(19) United States
(12) Patent Application Publication
(10) Pub. No.: US 2025/0305921 A1
(43) Pub. Date: Oct. 2, 2025

(54) A THERMOGRAVIMETRIC REACTOR (TGR) TO STUDY WEIGHT CHANGES OF SOLIDS AND A PROCESS THEREOF

(71) Applicant: COUNCIL OF SCIENTIFIC AND INDUSTRIAL RESEARCH, New Delhi (IN)

(72) Inventors: Prakash Dhondiram Chavan, Dhanbad (IN); Sujan Saha, Dhanbad (IN); Gajanan Sahu, Dhanbad (IN); Sudipta Datta, Dhanbad (IN); Vishal Chauhan, Dhanbad (IN); Nilesh Dhananjay Dhaigude, Dhanbad (IN); Pradeep Kumar Singh, Dhanbad (IN)

(21) Appl. No.: 18/863,571

(22) PCT Filed: May 6, 2022
(86) PCT No.: PCT/IN2022/050446

§ 371 Date: Nov. 6, 2024

(51) Int. Cl. G01N 5/04

(52) U.S. Cl. CPC G01N 5/04

(57) ABSTRACT

Thermogravimetric Reactor (TGR) and process to study weight change behavior of carbonaceous solids/catalysts during thermo-chemical reactions in gaseous environment up to the maximum operating temperature of 1000° C. and at atmospheric pressure are disclosed. The device includes a vertical tube reactor, digital weighing balance, gas feeding system equipped with volumetric flow controllers, rotameters, isolation valves and non-return valves to introduce inert and reactive gases and their mixtures to the reactor. It also has a movable electrical furnace heater for sudden heating/cooling of sample as per requirement. It also has sample feeding/loading system comprising containers of different sizes and shapes with a hanging arrangement There is arrangement to test the product gas composition with on line gas analyzer in the exit line or collecting the outgoing gas from the sampling port for off line gas analysis. The system also has control panel to store and display data including process parameters.

The following specification particularly describes the invention and the manner in which it is to be performed.

### FIELD OF THE INVENTION

The present invention relates to a thermogravimetric reactor (TGR) to determine weight changes of solids during thermo-chemical reactions. Particularly, the present invention relates to a TGR system which can determine the weight changes of any solids in lump/granular/powder form during thermo-chemical reactions under different gases, such as inert and different reactive gases including but not limited to air, O₂, CO₂, steam or their mixtures of any proportion up to the maximum operating temperature of 1000° C. and at atmospheric pressure.

### BACKGROUND OF THE INVENTION

Thermogravimetric analysis is one of the most common techniques available for rapid investigation, comparing thermal events and kinetics during the pyrolysis, combustion and gasification of solid materials. This method relies on the measurement of temporal variation of the sample mass as the reaction proceeds. It is cost effective, simple and easy to handle and that is why, it is most common. It is also very popular due to accurate and precise weight measurement with respect to time and temperature. High temperature (>1500° C.) thermogravimetric analyzers as well as pressurized systems are also available. It can explore the effects of various parameters, such as temperature, heating rate, residence time, pressure, gas composition and particle size on the gasification kinetics. Modern thermogravimetric analyzers with gas changing facilities during experimentation are also available. It is also possible to separate pyrolysis and gasification reactions in TGA due to the gas changing facility during experimentation. However, its disadvantages include low heating rate, low mass and gas through put, limitation to handle solids in lump/granular/powder form, limitation to introduce different inert and reactive gases including steam and their mixtures in any proportion, limitations with respect to operating conditions of sudden heating and cooling the sample, limitations for gas cooling, cleaning and out-going gas composition analysis. Therefore, extrapolation of obtained results to other systems of larger scale becomes restricted. Reference may be made to Chinese Patent No. CN103712881B, dated Jul. 6, 2016 wherein authors disclosed a kind of gram level material thermogravimetric and biogas production characteristics research experiment device. It consists of control station and electronic balance, the heating furnace, crucible for placing the sample, and for supporting the lifting support frame of electronic balance, the I type structure for lifting support frame, the vertical support frame bottom of lifting support frame connects on the drive motor being arranged in control station, electronic balance above the heating furnace is placed on the horizontal supporting plate of lifting support frame, there is a fixed mount below the horizontal supporting plate of lifting support frame to couple reaction pipe, crucible is arranged in reaction tube and connected to the spring leaf of electronic balance by running through the tinsel hook of the horizontal supporting plate of lifting support frame. Present invention achieves the test of large sample amount (balance range is 0-110 g, and precision is 0.1 mg). The thermogravimetric under the instantaneous soaking condition of sample and biogas production characteristics research can also be realized. However, the drawbacks of this devices are
The device has no gas feeding section which allows Inert gas (Nitrogen/Helium/Argon), reactive gases (Air, CO₂, O₂, steam) or their mixtures of any proportion (0-100%) to enter into the reactor through Pre-heater and mixer-cum-heater at hot condition
The gas feeding section of the present device is not equipped with any types of filter to filter the in-coming gases to the reactor.
The said device does not consist of any electrically heated steam generator along with a water metering pump to generate and supply measured quantity of steam to the reactor.
The said device has no balance chamber to house digital weighing balance with the provision of continuous inert gas purging to protect the balance from overheating as well as to shield from the corrosive and reactive gases produced in the reaction tube.
The device also does not have any jacketed spool piece with the provision of continuous inert gas purging placed between the balance and reactor tube to protect the balance from overheating, corrosive and reactive gaseous environment.
In he said device, the sample container is not capable to hold solids of any kind with varying particle sizes ranging from powder to lump form taking weight up to 100 g as the device has sample crucible of maximum volume of 40 cc.
The said device does not have any gas cooling and cleaning system comprising of condenser, scrubber.
As the device has not any gas cooling and cleaning system, the said device cannot be coupled with any on line gas analyzer system for out-going gas analysis.
The control panel of the present device does not mention about any safety alarm system, safety fuses, safety management inputs for power failure, high temperature limits, sensor burnout and shorting, high flow limits etc.
Moreover, the said device of this example is having lifting arrangement for the reaction tube and the balance. Therefore, the device may suffer from weight fluctuation during the movement of balance in order to sudden heating and cooling of the sample.

Yet another reference is made to Chinese Patent No. CN106153487B, dated Nov. 22, 2019, wherein a kind of novel Thermogravimetric Analysis Apparatus was disclosed. It includes specimen heating system, protective gas transportation system, temperature acquisition and automatic control system, weight acquisition system and data processing and control system. The specimen heating system is connected by heater element with sheet specimens with direct contact type. The temperature acquisition system is directly contacted by temperature sensor with sample with automatic control system and the weight acquisition system is connected by Weight-measuring device with lever weight transmitting device. The device can achieve very high heating rate of 400° C./minute with maximum sample weighing capacity of 500 mg. The drawbacks of this invention are
The said device is not capable to hold solids of any kind of high mass with varying particle sizes ranging from powder to lump form.
The device has no gas feeding section which allows Inert gas (Nitrogen/Helium/Argon), reactive gases (Air, CO₂, O₂, steam) or their mixtures of any proportion (0-100%) to enter into the reaction chamber through Pre-heater and mixer-cum-heater at hot condition.
The gas feeding section of the present device is not equipped with any types of filter to filter the in-coming gases to the reactor.
The said device does not consist of any electrically heated steam generator along with a water metering pump to generate and supply measured quantity of steam to the reactor.
In the said device, balance chamber does not have any provision of continuous inert gas purging to protect the balance from overheating as well as to shield from the corrosive and reactive gases produced in the reaction chamber.
The said device does not have any gas cooling and cleaning system.
The device does not have any arrangement of collecting out going gas for analysis.

Yet another reference is made to Chinese Patent no. CN107271320AB, dated Aug. 30, 2019, wherein a kind of thermogravimetric analyzer that can be achieved to be rapidly heated consisting of measuring apparatus, heating furnace, sample lowering or hoisting gear, protection lowering or hoisting gear and temperature control device were disclosed. The measuring apparatus includes pedestal platform and electronic balance. The heating furnace includes furnace seat and furnace body, resistive heater, setting-out channel, reaction gas air inlet pipe and reactor off-gas escape pipe. The sample lowering or hoisting gear includes the first actuating unit, the first transmission device, lifting platform and suspension rod. The protection lowering or hoisting gear includes the second actuating unit, the second transmission device and thermal insulation protection set. The temperature control device is connected with the heating furnace, for controlling the temperature of the burner hearth. The thermal insulation protection set of the present invention protects hanging basket, can elimination reaction initial stage data exception fluctuation, improve measurement integrality, reliability and accuracy. However, the drawbacks of this device are given below:
The said device is not capable to hold solids of any kind of high mass with varying particle sizes ranging from powder to lump form.
The device has no gas feeding section which allows Inert gas (Nitrogen/Helium/Argon), reactive gases (Air, CO₂, O₂, steam) or their mixtures of any proportion (0-100%) to enter into the reaction chamber through Pre-heater and mixer-cum-heater at hot condition.
The said device does not consist of any electrically heated steam generator along with a water metering pump to generate and supply measured quantity of steam to the reactor.
The said device does not consist of any electrically heated steam generator along with a water metering pump to generate and supply measured quantity of steam to the reactor.
The said device does not have movable furnace for the purpose of sudden heating/cooling of the sample as per process requirement.

Yet another reference is made to Chinese Patent no. CN103760054B, dated Feb. 24, 2019, wherein a kind of thermogravimetric analyzer for bulk specimen test was disclosed. It comprises of high-temperature reactor, electric furnace, hydraulic elevating platform, seal box and source of the gas and data control cabinet. High-temperature reactor is made up of inner and outer tubes. Outer tube top has reaction atmosphere air intake opening. First gas passes through outer tube circulating line and then bottom interior pipe, orifice plate upwards enters interior pipe and participates in reaction, make gas can fully be preheated. In addition, in high-temperature reactor, pipe top adopts expansion head, and two symmetrical gas outlets are set at the maximum cross-section place of expansion head. Electric furnace is set up on hydraulic elevating platform, and the outer tube of high-temperature reactor is inserted in electric furnace. Seal box is provided with protective atmosphere air intake opening, dividing plate in seal box is provided with load cells, above load cells, thermo pair is installed, be fixed on seal box top, load cells lower end is connected with suspension rod by the stainless-steel wire penetrating pipe in high-temperature reactor. Suspension rod lower end connects hanging basket for taking samples. Source of the gas comprises three gas bombs, such as oxygen, carbon dioxide and nitrogen. These gases and their mixtures can be introduced in to the system. Electric furnace provides desirable heating process for reacting, and maximum temperature can reach up to 1300° C. with measuring accuracy of 1° C. The maximum range of load cells is 500 g, and measuring accuracy is 10 mg. However, the drawbacks of the present invention are
The said device does not consist of any electrically heated steam generator along with a water metering pump to generate and supply measured quantity of steam to the reactor.
The gas feeding section of the present device is not equipped with any types of filter to filter the in-coming gases to the reactor.
The said device does not have any gas cooling and cleaning system comprising of condenser, scrubber.
As the device has not any gas cooling and cleaning system, the said device cannot be coupled with any on line gas analyzer system for out-going gas analysis.
The control panel of the present device does not mention about any safety alarm system, safety fuses, safety management inputs for power failure, high temperature limits, sensor burnout and shorting, high flow limits etc.

Yet another reference is made to Chinese Patent no. CN201532343U, dated Jul. 21, 2007, wherein a high temperature thermogravimetric analyser was disclosed. It comprises a high temperature test furnace, a mass measurement and display system, a temperature measurement control and display system, a furnace-in atmosphere and pressure control system. The mass sensor of described mass measurement system is arranged on the bottom of the hot test furnace body that is made of sealing bell, heater element, heat insulation furnace lining, the energy-conservation furnace lining of high temperature. A test sample is placed on a tray arranged on the upper portion of the quality sensor, which is stable, is convenient and reliable to operate. It is having lifting mechanism which is convenient and reliable to lift. The integral structure is simple and beautiful. Measuring accuracy of mass measurement sensor is higher and thermogravimetric curve is smoother. However, the drawbacks of this invention are
The said device is not capable to hold solids of any kind of high mass with varying particle sizes ranging from powder to lump form.
The device has no gas feeding section which allows Inert gas (Nitrogen/Helium/Argon), reactive gases (Air, CO₂, O₂, steam) or their mixtures of any proportion (0-100%) to enter into the reaction chamber through Pre-heater and mixer-cum-heater at hot condition.
The said device does not consist of any electrically heated steam generator along with a water metering pump to generate and supply measured quantity of steam to the reactor.
The said device does not have any gas cooling and cleaning system.
The device does not have any arrangement of collecting out going gas for analysis.
The said device does not have movable furnace for the purpose of sudden heating/cooling of the sample as per process requirement.

Yet another reference is made to Chinese Patent no. CN207516197U, dated Jun. 19, 2018, wherein a rapidly heated wide-range thermogravimetric analyzer was disclosed. It includes weighing system, reaction system, heating system and control system. Weighing system includes pedestal cabinet and electronic balance. Reaction system includes sample holder, dress sample metal mesh, high-temperature corundum pipe and the thermocouple for measuring sample temperature. Heating system includes apparatus for automatically lifting, cooling water protective device, lower thermal insulation layer, high-temperature heater, upper thermal insulation layer and sealing cover. Control system records sample quality, sample temperature, air inflow and water-flowing amount data in real time for controlling air inflow, cooling water protective device water-flowing amount, the furnace temperature of high-temperature heater and lifting. The device can be heated up to high temperature of 1500° C. at maximum ramp rate of 100° C./min. Weighing balance capacity is of 100 g and can take up to 20 g of coal samples in specially designed wire mesh sample holders. It is easy to operate and is having advantages of simple structure. However, the drawbacks of this device are
The said device is not capable to hold solids of any kind of high mass (100 g) with varying particle sizes ranging from powder to lump form.
The device has no gas feeding section which allows mixer of inert (Nitrogen/Helium/Argon) and reactive gases (Air, CO₂, O₂, steam) in any proportion (0-100%) to enter into the reaction chamber through Pre-heater and mixer-cum-heater at hot condition.
The said device does not consist of any electrically heated steam generator along with a water metering pump to generate and supply measured quantity of steam to the reactor.
The said device does not have movable furnace for the purpose of sudden heating/cooling of the sample as per process requirement.

Still another reference is made to South Korean Patent No. KR100440865B1, dated Jul. 19, 2004, wherein a Thermo-balance analyser equipped with heating tube and porous sample basket has was disclosed. This invention relates to a thermogravimetric analyzer for measuring particle size and weight change using a heating tube and a porous sampler. In order to achieve the above object, this invention provides a heating tube in which thermal and chemical reactions occur, a porous sample device installed axially movable inside a heating tube to facilitate reaction between a reaction gas and a solid sample, A thermogravimetric analyzer comprising a balance for weighing the sample, a balance moving part for moving the balancer and the sampler connected to the balance, and a cooling tube installed in a heating tube adjacent to the balance to prevent heat conduction to the heating tube. Therefore, according to the thermogravimetric analyzer of this invention, since the sample group is porous, the reaction with gas is easy, and by directly injecting a solid sample at a uniform temperature, it is possible to perform high-speed rate analysis and isothermal analysis as in a real reactor. However, the drawbacks of this device are
The said device is not capable to take solid sample up to 100 g.
Feeding section of this device allows only one gas at a time to enter into the reaction chamber. Mixing of different gases at any proportion is not possible.
The said device does not consist of any electrically heated steam generator along with a water metering pump to generate and supply measured quantity of steam to the reactor.
The said device does not have any gas cooling and cleaning system.
As the device has not any gas cooling and cleaning system, the said device cannot be coupled with any on line gas analyzer system for out-going gas analysis.

Still another reference is made to Korean Patent No. KR101116364B1, dated Mar. 9, 2012, wherein the authors disclose a thermogravimetric analyzer and its analysis method analyzing the sample quantitatively and precisely. This device includes a heating unit configured to heat a sample at a predetermined temperature, a sample mounting unit mounted on the sample while being able to move up and down inside the heating unit, a weight detection unit configured to detect a weight change as the sample is heated in the heating unit, a gas injection unit configured to inject the reactor body into the heating unit, a pressure regulator configured to adjust the pressure in the heating unit and a control unit connected to the respective units to control them. However, the drawbacks of the device are the said device is not capable to take solid sample up to 100 g.
Weighing detection unit of the device has no provision of continuous inert gas purging to protect the balance from overheating. However, it is having a water-cooled jacket mounted on the upper end of the heating tube via a sealing member. It protects the weighing detection unit from overheating. But its major drawback is that it will cause to condense the tar within the system leading to the chocking of the out-going gas outlet line which makes the system very problematic for coal/biomass/petcoke handling which are having significant amount of volatile mattes.
The said device does not have any gas cleaning system.
As the device has not any gas cleaning system, the said device cannot be coupled with any on line gas analyzer system for out-going gas analysis.
The control panel of the present device does not mention about any safety alarm system, safety fuses, safety management inputs for power failure, high temperature limits, sensor burnout and shorting, high flow limits etc.

Yet another reference is made to Chinese Patent Application No. CN103712877A, dated Apr. 9, 2014, wherein the authors disclose a thermogravimetric characteristic analysis system for massive test specimen supercritical water gasification. The system comprises an electronic balance, a main reaction kettle and a heating furnace, wherein a material bucket is suspended in the main reaction kettle; the material bucket is suspended at one end of the electronic balance, and a balancing bucket is suspended at the other end of the electronic balance, and is connected with a computer. The main reaction kettle and the heating furnace are sealed bodies. The system also comprises an inert gas source connected with the main reaction kettle, a high-pressure pump and a de-ionized water storage tank, wherein de-ionized water enters the high-pressure pump, and enters the main reaction kettle after being pressurized; the material bucket is made from a steel wire mesh. According to the system, the shortcoming that thermogravimetric characteristic analysis and researches can be made by a conventional device only under a normal pressure condition is overcome; in addition, thermogravimetric experimental researches on a supercritical water gasification process of a massive test specimen (being more than 100 grams) can be made. However, the drawbacks of the system are.
Gas feeding section of the device does not allow mixing of inert (Nitrogen/Helium/Argon) and reactive gases (Air, CO₂, O₂, steam) in any proportion (0-100%) and to enter into the reaction chamber through Pre-heater and mixer-cum-heater at hot condition.
The said device does not have movable furnace for the purpose of sudden heating/cooling of the sample as per process requirement.
The control panel of the present device does not mention about any safety alarm system, safety fuses, safety management inputs for power failure, high temperature limits, sensor burnout and shorting, high flow limits etc.

Reference may be made to an article entitled, Experimental methods in chemical engineering: Thermogravimetric analysis—TGA discloses thermogravimetric analysis (TGA) as a quantitative analytical technique that monitors the mass of a sample from 1 mg to several g as a furnace ramps temperature to as high as 1600° C. under a stable or changing gas flow. It provides the basic principle and function of the modern TGA, such as Fluidized bed-thermogravimetric analyzer (FB-TGA), induction heating fluidized bed analyzer (IHFB-TGA) and microwave (MWTGA) thermogravimetric analyzer.

However, the drawbacks with respect to present invention as well as the technical advancements made in the present device in comparison to the referred article are described below:

The devices mentioned in the article are not capable to hold solids in lump/granular/powder form with varying particle sizes ranging from micron level to 25 mm taking weight in the wide range of mg level to 100 g.

The present invention differs from the devices mentioned in the article in sample feeding/loading mechanism comprising of a set of well-designed sample containers of different sizes and shape.

The devices mentioned in the article do not have movable heating furnace for upward and downward movement along the length of the reactor for the purpose of sudden heating/cooling of the sample as per the process requirement.

The devices mentioned in the article do not have such feeding section which allows inert gas (Nitrogen/Helium/Argon), reactive gases (Air, CO₂, O₂, steam) or their mixtures of any proportion (0-100%) to enter into the reactor through Pre-heater and mixer-cum-heater at hot condition.

The gas feeding sections of the devices mentioned in the article are not equipped with any types of filter to filter the in-coming gases to the reactor.

The devices mentioned in the article do not mention about any gas cooling and cleaning system comprising of condenser and scrubber.

The present invention also differs from the systems mentioned in the article in protection mechanism of digital weighing balance as well as in safety managements inputs for power failure, high temperature limits, sensor burnout and shorting, high flow limits, safety management outputs to terminate power to heaters.

The devices are basically having small sample taken capacity in mg level without steam generator, devoid of gas mixing facility of different inert & reactive gases in any proportion, and do not having arrangement for sudden heating/cooling as per process requirement.

All the inventions as stated above describe specific designs and related process corresponding to different kinds of thermogravimetric analysis setup having limited flexibility to feed material and operating conditions, whereas for further development in this emerging area towards developing thermogravimetric reactor capable to handle different kinds of solid materials in any form of lump/granular/powder of high mass capacity with steam generator and movable furnace for the purpose of sudden heating and cooling has become essential.

### OBJECTIVES OF THE INVENTION

Main object of the present invention is to provide a Thermogravimetric Reactor (TGR), to study weight changes behavior during thermo-chemical reactions of solids in lump/granular/powder form in the gaseous environment of different gases and process thereof. Another objective of the present invention is to study weight changes during thermo-chemical reactions of solids taking weight up to 100 g in lump/granular/powder form under different gases, such as inert and different reactive gases including but not limited to N₂, Ar, He, air, O₂, CO₂, steam or their mixtures of any proportion up to the maximum operating temperature of 1000° C. and at atmospheric pressure.

Yet another objective of the present invention is to study weight loss as well as weigh gain behavior of any solids in lump/granular/powder form taking weight up to 100 g under different gaseous environment up to the operating temperature of 1000° C. and at atmospheric pressure. Another objective of the present invention is to study weight changes during pyrolysis of solids in lump/granular/powder form in the gaseous environment of different inert gases to determine isothermal and non-isothermal reactivity and kinetics up to the maximum operating temperature of 1000° C.

Yet another objective of the present invention is to study weight changes during combustion and gasification reactions of solids in lump/granular/powder form in the gaseous environment of different reactive gases to determine isothermal and non-isothermal reactivity and kinetics up to the maximum operating temperature of 1000° C.

Still another objective of the present invention is to study combustion and gasification reactivity and kinetics of different solids in lump/granular/powder form, so that the reactivity will reflect overall (apparent) reactivity of feed samples in its original size to depict the actual phenomena taking place inside the gasifier as well as to study intrinsic (diffusion free) and extrinsic (diffusion resistance) kinetics.

Still another object of the present invention is to start and stop thermo-chemical reactions of any solids suddenly up to the temperature of 1000° C. with the help of movable electric furnace, so that it exerts the similar effects of heat of a commercial gasifier/combustor.

Still another purpose of the present invention is to study carbon conversion of solids from 0-100% as desire with the provision of the movable electric furnace fitted with reactor as well as to test gas composition with the help of on-line gas analyzer coupled with the system or collecting the coming out gas from the sampling port with the help of any gas sample collection arrangement for off line gas analysis purpose.

### SUMMARY OF THE INVENTION

Accordingly, present invention provides a Thermogravimetric Reactor (TGR) comprising Gas Station with manifold & Gas metering [FIG. 1, 1] being connected to Mixer-Cum-Super Heater [FIG. 1, 4] through Gas Pre-heater [FIG. 1, 2] and Electrically heated Steam Generator [FIG. 1, 3]; Reactor [FIG. 1, 11] being connected to Movable Furnace [FIG. 1, 12] and Jacketed Spool Piece [FIG. 1, 9] placed between the balance chamber [FIG. 1, 7] and the reactor [FIG. 1, 11], Sample Container [FIG. 1, 13] having provision of hanging arrangement from the weighing balance [FIG. 1, 8] with chain/wire [FIG. 1, 10] placed at the middle of the heating zone of the furnace heater inside the reactor [FIG. 1, 11] just above the reactor temperature element [FIG. 1, 14], being connected to Condenser-Cum-Cooler [FIG. 1, 15], Collection Pot [FIG. 1, 16], Back Pressure Regulator [BPR] [FIG. 1, 17], Scrubbers [FIG. 1, 18], Gas Flowmeter [FIG. 1, 19] and Gas Sampling Port [FIG. 1, 20],
wherein

Electrically heated Steam Generator [FIG. 1, 3] is further connected to Water Metering Pump [FIG. 1, 5] and Water Tank [FIG. 1, 6]
weighing Balance [FIG. 1, 8] being connected to PLC-SCADA for control and Data Acquisition [FIG. 1, 21].

In an embodiment of the present invention, Gas Station with manifold & Gas metering [FIG. 1, 1] comprising:
i. one rotameter, capacity of 10 LPM to 100 LPM along with needle valve in the by-pass line to volumetric flow controller;
ii. micron filters to filter the in-coming gases to the reactor and;
iii. isolation valve;
iv. non-return valves which allows various gases including but not limited to Inert gas (Nitrogen/Helium/Argon), reactive gases (Air, CO₂, O₂, steam) or their mixtures of any proportion to enter into the reactor through Pre-heater and mixer-cum-super heater with controlled flow through volumetric flow controllers (0.5 LPM to 100 LPM);
v. pressure gauges to monitor inlet pressure;
   wherein before entering into the pre-heater [FIG. 1, 2], Gas feeding line is fitted with isolation valves and non-return valves for the purpose of introduction and stop of the flow as and when required as well as to prevent the back flow of the gas.

In another embodiment of the present invention, both the gas pre-heater [FIG. 1, 2] and mixer-cum-super heater [FIG. 1, 4] can heat the gas up to 400° C. and both are equipped with thermocouples, safety valves and rupture discs.

In yet another embodiment of the present invention, said reactor has an electrically heated steam generator [FIG. 1, 3] along with a water metering pump [FIG. 1, 5] of capacity 50-1000 ml/h to generate super-heated steam up to the temperature of 400° C. and electrically heated steam generator [FIG. 1, 3] is equipped with thermocouples to measure heater temperature and inside temperature as well as having safety valve and rupture disc.

In yet another embodiment of the present invention, said reactor has balance chamber [FIG. 1, 7] above the reactor [FIG. 1, 11] to house digital weighing balance [FIG. 1, 8] to measure the accurate weight of the solid materials placed inside the reactor and balance chamber [FIG. 1, 7] and having provision of continuous inert gas purging to protect the balance from overheating as well as to shield from corrosive and reactive gaseous environment.

In yet another embodiment of the present invention, said reactor has jacketed spool piece [FIG. 1, 9] with the provision of continuous inert gas purging as well as circulation is placed between the balance chamber [FIG. 1, 7] and the reactor [FIG. 1, 11] to protect the balance from the overheating, corrosive and reactive gaseous environment.

In yet another embodiment of the present invention, said reactor has easily removable high temperature alloy vertical tube flanged end type Reactor [FIG. 1, 11] with electrically heated furnace [FIG. 1, 12] of operating temperature up to 1000° C. and pressure 1 atmosphere having 4 inches NB diameter and 2 meter length, having provision of upward and downward movement of the furnace along the length of the reactor for the purpose of sudden heating/cooling of the sample as per the process requirement.

In yet another embodiment of the present invention, tube is of 80 Schedule pipe made of suitable alloy, incoloy such that it can withstand maximum operating temperature of 1000° C. [FIG. 1, 11].

In yet another embodiment of the present invention, the device has a set of sample container [FIG. 1, 13] of different sizes and shapes,
capable to hold solids in lump/granular/powder form with varying particle sizes ranging from micron level to 25 mm taking weight in the wide range of mg level to 100 g;
made of suitable alloy/ceramic material;
having provision of hanging arrangement from the weighing balance with chain/wire [FIG. 1, 10] of adjustable length made of suitable alloy such that sample container is placed at the middle of the heating zone of the furnace heater inside the reactor just above the reactor temperature element [FIG. 1, 14] for measuring the sample temperature accurately.

In yet another embodiment of the present invention, said reactor has Nitrogen flushing arrangement to tackle any kind of emergency during operation by diluting reactant components in the reactor to stop sudden temperature shoot-up.

In yet another embodiment of the present invention, said reactor has weighing balance [FIG. 1, 8] of capacity up to 250 g with the accuracy of 0.0001% is connected with PLC-SCADA for control and Data Acquisition [FIG. 1, 21] to record the weight changes of sample continuously with time and temperature.

In yet another embodiment, present invention provides a process to study weight changes behaviour of solids during thermo-chemical reactions in the gaseous environment of different gases at high temperature and atmospheric pressure using Thermogravimetric Reactor (TGR) as claimed in claim 1 comprising the steps of:
i. taking solid sample in lump/granular/powder form up to 100 g in the sample container;
ii. hanging the sample containing crucible inside the reactor by chain of adjustable length from the bottom of the weighing balance;
iii. switch on of the weighing balance and closing of the balance chamber as well as switch on of the PLC-SCADA Control and Data Acquisition system;
iv. starting of Nitrogen gas purging in the balance chamber at the rate of 1 LPM;
v. lifting of the reactor furnace up to the marked position of the reactor such that sample containing bucket remains at the middle of the furnace;
vi. starting of gas flow of Nitrogen at the rate of 1-10 LPM;
vii. starting of gas flowmeter and water circulation in the condenser;
viii. switch on of the pre-heater and mixer-cum-heater and setting of temperature at 400° C.;
ix. switch on of steam generator as per requirement and setting of temperature at 400° C.;
x. switch on Reactor furnace and setting of desired temperature up to 1000° C.;
xi. after reaching the desired temperature of reactor furnace, introduction of desired reactive gas flow of air/CO₂/steam or their mixture at the rate of 1-10 LPM to the reactor and stopping of N₂ flow through the reactor.
xii. after reaching the desired temperature of reactor furnace as well as setting desired gas flow through the reactor, as per the requirement of experiment design of sudden heating and cooling, lifting of furnace along the length of the reactor to the pre-determined position such that the sample container remained at the middle of the furnace (in this case, furnace remained in down position earlier);
xiii. starting of Gasification reaction in desired atmosphere of Air/Air-steam/CO₂an their mixture in any proportion;
xiv. collection of out-going gas from the sample port for off line gas analysis as per requirement or coupling of online gas analyzer for instant analysis.
xv. after completion of the reaction, switch off of the steam genitor, water metering pump, all the furnaces and reactive gaseous flow; starting of N₂ flow at the rate of 3 LPM through the reactor;
xvi. recording of the data through control panel was stopped and taken the data and graphs for study and calculation;
xvii. placing down the furnace heater along the reactor to its pre-marked position;
xviii. after cooling the reactor tube, switch off of the weighing balance, stopping of N₂ flow through balance chamber, opening of the balance chamber and taking out of sample bucket.

In yet another embodiment of the present invention, said device is to study weight changes behaviour
of any carbonaceous solids and catalysts;
in lump/granular/powder form with varying particle sizes ranging from micron level to 25 mm;
taking weight in the wide range of mg level to 100 g;
during thermo-chemical reactions (solid-gas, gas-gas) in the gaseous environment of different gases, such as inert and different reactive gases including but not limited to N₂, Ar, He, air, O₂, CO₂, steam or their mixtures of any proportion (0-100%) up to the maximum operating temperature of 1000° C. and at atmospheric pressure;
during pyrolysis/combustion/gasification/different types of gas-solid reactions/catalytic gas-gas reactions/isothermal and non-isothermal reactivity and kinetics of different reactive solids or solids having catalytic potentiality in lump/granular/powder form having particle sizes from micron level to 25 mm and taking weight in the wide range of mg level to 100 g, so that the reactivity reflects overall (apparent) reactivity of feed samples in its original size to depict the actual phenomena taking place inside the gasifier as well as to study intrinsic (diffusion free) and extrinsic (diffusion resistance) kinetics.

In yet another embodiment of the present invention, said reactor has on line gas analyzer connected with Gas Sampling Port [FIG. 1, 20] to test product gas composition with the help of in the exit line or collecting the outgoing gas from the sampling port [FIG. 1, 20] with the help of any gas sample collection arrangement for off line gas analysis purpose.

In yet another embodiment of the present invention, said reactor has entire tubing from steam generator to reactor is heat traced to maintain temperature up to 400° C. and gas line after mixer-cum-super heater is fed to the reactor in such a position that it is just above the heating zone of the reactor for not allowing the condensation of steam.

In yet another embodiment of the present invention, said reactor has process control and data acquisition system comprising of PLC-SCADA control station along with alarm system, safety fuses, safety managements inputs for power failure, high temperature limits, sensor burnout and shorting, high flow limits, safety management outputs to terminate power to heaters.

In yet another embodiment of the present invention, said reactor has gas feeding system with inlet temperature up to 400°° C., comprising of pre-heater up to 400°° C., steam generator with water metering pump, mixer-cum-super heater up to 400°° C., volumetric flow controllers, rotameters, isolation valves, non-return valves, micron filters and pressure gauges.

In yet another embodiment of the present invention, said reactor has control panel with data acquisition system comprising of PLC-SCADA control station along with printer, individual heating controllers with MCBs, safety alarm system, safety fuses, safety managements inputs for power failure, high temperature limits, sensor burnout and shorting, high flow limits, management outputs to terminate power to heaters. The system is completely automated through programmable logical controller to maintain its gas flow, temperature, pressure. PLC record all the parameters including temperature, weight, time, flow rates of gases and steam, graphical trends of the all parameters and alarms. PLC philosophy is designed to get the required graphs with respective parameters.

### BRIEF DESCRIPTION OF THE DRAWING

FIG. 1 represents the Thermogravimetric Reactor (TGR) comprising of various components 1-21 as embodied in the FIG. 1. 1) Gas Station with manifold & Gas metering; 2) Gas Pre-heater; 3) Electrically heated steam generator; 4) Mixer-Cum-Super Heater; 5) Water Metering Pump; 6) Water Tank; 7) Balance Chamber; 8) Digital Balance; 9) Jacketed Spool Piece; 10) Chain/Wire; 11) Reactor; 12) Movable Furnace; 13) Sample Container; 14) Reactor Temperature Element; 15) Condenser-Cum-Cooler; 16) Collection Pot; 17) Back Pressure Regulator (BPR); 18) Scrubbers; 19) Gas Flowmeter; 20) Sampling Port; 21) PLC-SCADA for control and Data Acquisition.

FIG. 2 represents weight changes behaviour of coal of different sizes during gasification in CO₂ at 900° C.

FIG. 3 represents weight changes behaviour of coal samples of same particle size during gasification under Air, Air-Steam and CO₂ atmosphere at 1000° C.

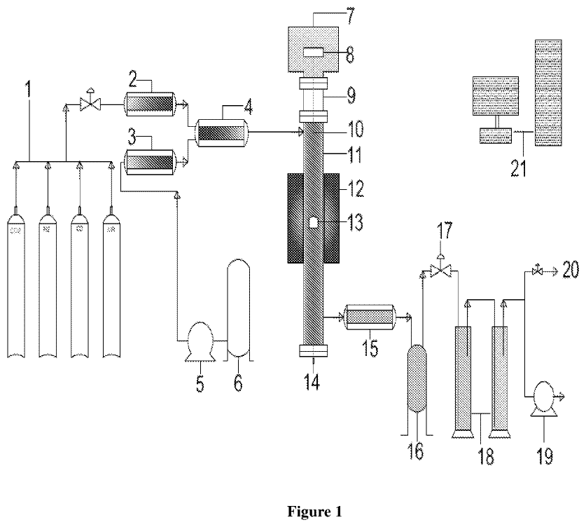

### DETAILED DESCRIPTION OF THE INVENTION

Present invention provides a Thermogravimetric Reactor (TGR) having a vertical tube reactor of suitable alloy to withstand high operating temperature up to 1000° C., having gas feeding system equipped with volumetric flow controllers, rotameters, isolation valves and non-return valves to introduce various inert and reactive gases and their mixtures to reactor section, having water metering pump and steam generator with steam flow range from 50-1000 ml/h, having suitable sample feeding/loading system comprising of a set of well-designed sample containers of different sizes and shapes made of suitable alloy/ceramic with sample taking capacity up to 100 gm, having gas pre-heater for heating gases up to 400° C., having mixer-cum-super heater for mixing and heating reactant-steam mixture up to 400° C., having digital weighing balance to exhibit exact weight of the solid materials, having movable electrically heated furnace heater, having post reaction gas cooling, condensing, scrubbing and cleaning system with the provision of collecting the outgoing gases through sampling port, having control panel to store and display all the data including process parameters.

Present invention provides a Thermogravimetric Reactor (TGR) consisting of various sections, namely gas feeding section, reactor section, gas cooling and cleaning section and control panel. The four basic sections are skid mounted to hold corresponding main equipments, instrumentation, valves & fittings, piping/tubing and other required items. All tubing/piping are of seamless type. Detailed descriptions of each section are as follow:

### i. Gas Feeding Section

Inert gas (Nitrogen/Helium/Argon), reactive gases including but not limited to air, O₂, CO₂, or their mixtures of any proportion are allowed to enter into the reactor through Pre-heater and mixer-cum-super heater with controlled flow through volumetric flow controllers (air/O₂/CO₂/inert gas flow rate from 0.5 LPM to 100 LPM). One rotameter, capacity of 10LPM to 100 LPM along with needle valves is also present in the by-pass line to volumetric flow controller. Before entering into the pre-heater, Gas feeding line is fitted with isolation valves and non-return valves for the purpose of introduction and stop of the flow as and when required as well as to prevent the back glow of the gas, respectively. This section is also equipped with micron filters to filter the in-coming gases to the reactor. The inlet pressure is being monitored by the pressure gauges.

### ii. Electrically Heated Steam Generator and Water Metering Pump

The system consists of an electrically heated steam generator along with a water metering pump of capacity 50-1000 ml/h to generate super-heated steam up to the temperature of 400° C. Rate of steam is measured by measuring the water flow rate and a measured quantity of steam from steam generator is allowed to enter into the mixer-cum-super heater through isolation valve as per the requirement. Steam generator is equipped with a thermocouple to measure inside temperature as well as having safety valve and rupture disc of suitable rating.

### iii. Gas Pre-Heater and Mixer-Cum-Super Heater

The system consists of a gas pre-heater for heating the incoming gas up to the temperature of 400°° C. It also consists of a mixer-cum-super heater to mix the gases and steam properly up to the temperature of 400° C. before entering into the reactor. Both the pre-heater and mixer-cum-super heater are fitted with thermocouples for indicating inside temperatures as well as they have safety valves and rupture discs of suitable rating. Entire tubing from steam generator to reactor is heat traced to maintain temperature up to 400° C. and gas line after mixer-cum-super heater is fed to the reactor in such a position that it is just above of the heated zone of the reactor for not allowing the condensation of steam. This position is determined considering the position of the movable furnace (placed along the reactor length in such a way that the sample container appears at the middle of the heating zone of the heater) during stable operation of the TGR system.

### iv. Reactor Tube and Movable Furnace

The present invention comprising of an easily removable vertical tube flanged end type reactor with electrically heated furnace of operating temperature up to 1000° C. and pressure 1 atmosphere, having 4 inches NB diameter and 2 meter length. Tube is of 80 Schedule pipe made of suitable alloy such that it can withstand maximum operating temperature of 1000° C. Heating furnace is having provision of upward and downward movement along the length of the reactor for the purpose of sudden heating/cooling of the sample as per process requirement. One thermocouple is inserted in the heater to measure furnace and reactor surface temperature as well as another thermocouple is inserted inside the reactor from bottom flange and placed just below the sample container/holder to show sample temperature. Top portion of the reactor is provided with removable flange connection so as to insert and remove the sample container before and after each experiment.

### v. Balance Chamber, Digital Balance and Sample Feeding/Loading Arrangement

The present device has thermally isolated balance chamber above the reactor tube to house digital weighing balance to measure the accurate weight of the solid sample materials placed inside the reactor. The said balance chamber has provision of continuous inert gas purging to protect the balance from overheating as well as to shield from the corrosive and reactive gaseous environment. Further, jacketed spool piece with the provision of continuous inert gas purging as well as circulation through jacket has been placed between the balance chamber and the reactor tube to protect the balance from overheating, corrosive and reactive gaseous environment. Weighing balance is capable to show accurate weight change of the solids up to 100 g with the accuracy of 0.0001%, having suitable sample feeding/loading system comprising of a set of well-designed sample containers of different sizes and shapes, capable to hold solid samples up to 100 g in lump/granular/powder form having particle size from micron level to 25 mm, made of suitable alloy/ceramic material with a provision of hanging arrangement of the sample container from the weighing balance with the help of chain/wire of adjustable length made of suitable alloy such that sample container is placed at the middle of the heating zone of the heater inside the reactor just above the thermocouple for measuring the sample temperature accurately. Weighing balance is connected with PLC-SCADA to record the weight changes of sample continuously with time and temperature during experimentation. As there is movement of gases from upward direction to downward inside the reactor along its length, unused and generated product gas are discharged from the bottom portion of the reactor and enter to the gas cooling and cleaning section.

### vi. Gas Cooling and Cleaning Section

The said device has gas cooling and cleaning system comprising of water cooled condenser, collection pot, back pressure regulator (BPR), set of scrubbers, gas flow meter and gas sampling port. A water cooled condenser and collection pot are provided after the reactor in product gas line to condense and separate the unconsumed steam and tarry material if any. Back pressure regulator (BPR) is fitted after the condenser to control the reactor pressure. The excess gas is released from the Back pressure regulator (BPR) and passes through check valve for avoiding the back flow of water. Glass scrubbers are attached after the BPR for cleaning the product gases coming from the reactor. The uncondensed and clean gas from the scrubber is vented after passing through the volumetric wet gas flow meter. There is also arrangement to test product gas composition with the help of on line gas analyzer coupled with the system in exit line or collecting the coming out gas from the sampling port with the help of any gas sample collection arrangement for off line gas analysis purpose.

### vii. PLC-SCADA Control System

The said device has control panel with data acquisition system comprising of PLC-SCADA control station along with printer, individual heating controllers with MCBs, alarm system, safety fuses, safety managements inputs for power failure, high temperature limits, sensor burnout and shorting, high flow limits, safety management outputs to terminate power to heaters. The system is completely atomized through programmable logical controller to maintain its gas flow, temperature, pressure. PLC record all the parameters, all parameters trends and alarms. PLC philosophy is designed to get the required graphs with respective parameters.

The inventive steps involved in the present invention are
i. Innovative Thermogravimetric Reactor (TGR) is to study weight changes behaviour of any kind of carbonaceous solids or solids having catalytic potentiality in lump/granular/powder form having particle sizes from micron level to 25 mm.
ii. Innovative Thermogravimetric Reactor (TGR) is to study weight changes behaviour of any solids in lump/granular/powder form taking weight up to 100 g during thermo-chemical reactions in the gaseous environment of different gases, such as inert and different reactive gases including but not limited to N₂, Ar, He, air, O₂, CO₂, steam or their mixtures of any proportion up to the maximum operating temperature of 1000°° C. and at atmospheric pressure.
iii. Innovative TGR has easily removable high temperature alloy vertical tube flanged end type reactor with electrically heated furnace of operating temperature up to 1000° C. and pressure 1 atmosphere, having provision of upward and downward movement of furnace along the length of the reactor for the purpose of sudden heating/cooling of the sample as per process requirement. One thermocouple is inserted inside the heater to measure furnace and reactor surface temperature as well as another thermocouple is inserted inside the reactor from bottom flange and placed just below the sample container to show sample temperature. Top portion of the reactor is provided with removable flange connection so as to insert and remove the sample container before and after each experiment.
iv. The present innovative device has balance chamber above the reactor tube to house digital weighing balance to measure the accurate weight of the solid materials placed inside the reactor. The said balance chamber has provision of continuous inert gas purging to protect the balance from overheating as well as to shield from the corrosive and reactive gaseous environment. Further, jacketed spool piece with the provision of continuous inert gas purging as well as circulation through jacket has been placed between the balance chamber and the reactor tube to protect the balance from overheating, corrosive and reactive gaseous environment.

v. The present innovative device has suitable sample feeding/loading system comprising of a set of well-designed sample container/holders of different sizes and shapes, capable to hold solids in lump/granular/powder form having particle sizes from micron level to 25 mm and weight up to 100 g, made of suitable alloy/ceramic material with a provision of hanging arrangement of the sample container from the weighing balance with chain/wire of adjustable length made of suitable alloy such that sample container is placed at the middle of the heating zone of the furnace heater inside the reactor just above the thermocouple for measuring the sample temperature accurately.
vi. The present device has also innovative arrangement to test product gas composition with the help of on line gas analyzer coupled with the system in exist line or collecting the outgoing gas from the sampling port with the help of any gas sample collection arrangement for off line gas analysis purpose.
vii. The present innovative device is capable to study pyrolysis/combustion/gasification/different type of gas-solid reactions/catalytic gas-gas reactions/isothermal and non-isothermal reactivity and kinetics of different reactive solids or solids having catalytic potentiality in lump/granular/powder form having particle sizes from micron level to 25 mm and taking weight in the wide range of mg level to 100 g, so that the reactivity reflects overall (apparent) reactivity of feed samples in its original size to depict the actual phenomena taking place inside the reactor as well as to study intrinsic (diffusion free) and extrinsic (diffusion resistance) kinetics.

### EXAMPLES

The following examples are given by way of illustration of the present invention and therefore should not be construed to limit the scope of the present invention.

### Example 1: Working of the Present Device and Process

At first, the power supply and water supply was checked before switch on the TGR test facility and desired quantity of solid sample (in lump/granular/powder form up to 100 g) was taken in the crucible.
Next the sample containing crucible was hanged inside the reactor by chain of adjustable length from the bottom of the weighing balance.
Weighing balance was Switched on and the balance chamber was closed.
Nitrogen gas purging was started and flow was fixed 1 LPM., gas leak through the lid of the balance chamber was also checked.
Furnace was lifted up to the marked position of the reactor such that sample containing bucket remained at the middle of the furnace.
Desired gas flow of Nitrogen at the rate of 3 LPM was started.
Wet gas meter and water circulation were started
Pre-heater and mixer-cum-heater were switched on and temperature was set at 400° C.
If required steam generator was switched on and temperature was set at 400° C.
Reactor furnace was switched on and desired temperature was set.
After reaching the desired temperature of reactor furnace, desired reactive gas flow of air/CO₂/steam or their mixture was introduced to the reactor and N₂ flow was stopped through the reactor.
If the experiment was designed for sudden heating of the sample, in that case, furnace heater was not lifted earlier and left in down position. After reaching the desired temperature of reactor furnace as well as setting desired gas flow through the reactor, furnace was lifted along the length of the reactor to the pre-determined position such that the sample container remained at the middle of the furnace.
Gasification reaction was started in desired atmosphere of Air-steam mixture/CO₂.
After completion of the reaction, steam genitor and water metering pump, all the furnaces were switched off; reactive gas flow was stopped and N₂ flow was started through the reactor.
Recording of the data through control panel was stopped and taken the data and graphs for study and calculation.
Furnace heater was taken down along the reactor to its pre-marked position.
After cooling the reactor, weight balance was switched off, balance chamber was open and sample bucket was taken out.

TABLE 1
Experimental conditions for TGR test facility using CO₂ as
reactive gases with different sample sizes of coal

| | Sample size | Initial | Final Wt | Gasifying | Temp | Flow rate |
|---|---|---|---|---|---|---|
| Run | (mm) | wt (g) | (g) | agent | [oC] | LPM |
| I | 6 | 5.20 | 2.87 | CO₂ | 900 | 3 |
| II | 10 | 5.30 | 2.79 | CO₂ | 900 | 3 |
| III | 15 | 5.40 | 2.48 | CO2 | 900 | 3 |
| IV | 20 | 6.10 | 3.37 | CO2 | 900 | 3 |

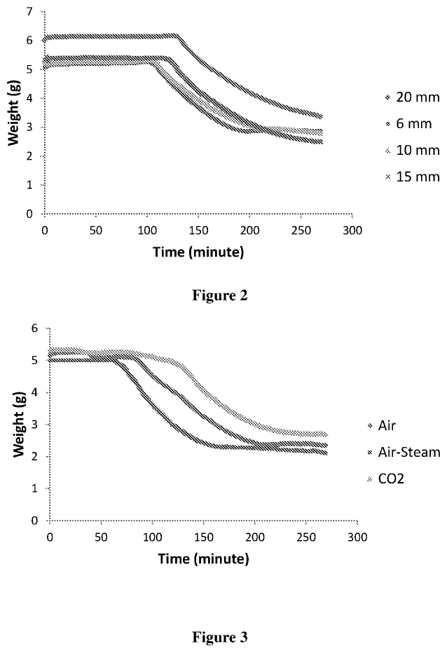

Weight changes behaviour of coal samples of different sizes during gasification under CO₂ atmosphere at 900° C. are shown in FIG. 2.

TABLE 2
Experimental conditions for TGR test facility using different
reactive gases with same sample size of coal samples

| | Sample | Initial wt | Final Wt | Gasifying | Temp | Flow rate |
|---|---|---|---|---|---|---|
| Run | Size | (g) | (gram) | agent | (° C.) | (LPM) |
| I | 10 mm | 5 | 2.10 | Steam-air | 1000 | 3(1 + 2) |
| II | 10 mm | 5.2 | 2.35 | air | 1000 | 3 |
| III | 10 mm | 5.3 | 2.69 | CO₂ | 1000 | 3 |

Weight changes behaviour of coal samples of same particle size during gasification under Air, Air-Steam and CO₂ atmosphere at 1000° C. are shown in FIG. 3

### Advantages of the Invention

The present invention has easily removable high temperature alloy vertical tube flanged end type reactor with electrically heated furnace of operating temperature up to 1000° C. and pressure 1 atmosphere, having provision of upward and downward movement of furnace along the length of the reactor for the purpose of sudden heating/cooling of the sample as per process requirement.

Present device has wide range of operational flexibility with respect to temperature, sample type (lump/granular/powder form), sample weight gaseous reactant, residence time, particle size and particle density.

The present device has balance chamber above the reactor tube to house digital weighing balance to measure the accurate weight of the solid materials up to 100 g of weight with the accuracy of 0.0001%.

The said balance chamber has provision of continuous inert gas purging to protect the balance from overheating as well as to shield from the corrosive and reactive gaseous environment.

Moreover, jacketed spool piece with the provision of continuous inert gas purging as well as circulation through jacket has been placed between the balance chamber and the reactor tube to protect the balance from the overheating, corrosive and reactive gaseous environment.

The said device has gas cooling, condensing, scrubbing and cleaning system to remove contaminants from the product gas.

There is also arrangement to test product gas composition with the help of on line gas analyzer coupled with the system in the exit line or collecting the outgoing gas from the sampling port with the help of any gas sample collection arrangement for off line gas analysis purpose

The said device has control panel with data acquisition system to record sample weight changes with temperature and time during experimentation. The system is completely automated through programmable logical controller to maintain its gas flow, temperature, pressure. PLC records all the parameters including temperature, weight, time, flow rates of gases and steam, graphical trends of the all parameters and alarms. PLC philosophy is designed to get the required graphs with respective parameters. It has all safety measures including safety alarm system, safety fuses, safety managements inputs for power failure, high temperature limits, sensor burnout and shorting, high flow limits, management outputs to terminate power to heaters.

1. A Thermogravimetric Reactor (TGR) comprising Gas Station with manifold & Gas metering being connected to Mixer-Cum-Super Heater through Gas Pre-heater and Electrically heated Steam Generator; Reactor being connected to Movable Furnace and Jacketed Spool Piece placed between the balance chamber and the reactor, Sample Container having provision of hanging arrangement from the weighing balance with chain/wire placed at the middle of the heating zone of the furnace heater inside the reactor just above the reactor temperature element, being connected to Condenser-Cum-Cooler, Collection Pot, Back Pressure Regulator, Scrubbers, Gas Flowmeter and Gas Sampling Port,
wherein
Electrically heated Steam Generator is further connected to Water Metering Pump and Water Tank;
weighing Balance being connected to PLC-SCADA for control and Data Acquisition.

2. The Thermogravimetric Reactor (TGR) as claimed in claim 1, wherein Gas Station with manifold & Gas metering comprising:
i. one rotameter, capacity of 10 LPM to 100 LPM along with needle valve in the by-pass line to volumetric flow controller;
ii. micron filters to filter the in-coming gases to the reactor and;
iii. isolation valve;
iv. non-return valves which allows various gases including but not limited to Inert gas (Nitrogen/Helium/Argon), reactive gases (Air, CO₂, O₂, steam) or their mixtures of any proportion to enter into the reactor through Pre-heater and mixer-cum-super heater with controlled flow through volumetric flow controllers (0.5 LPM to 100 LPM);
v. pressure gauges to monitor inlet pressure;
wherein before entering into the pre-heater, Gas feeding line is fitted with isolation valves and non-return valves for the purpose of introduction and stop of the flow as and when required as well as to prevent the back flow of the gas.

3. The Thermogravimetric Reactor (TGR) as claimed in claim 1, wherein both the gas pre-heater and mixer-cum-super heater can heat the gas up to 400° C. and both are equipped with thermocouples, safety valves and rupture discs.

4. The Thermogravimetric Reactor (TGR) as claimed in claim 1, wherein said reactor has an electrically heated steam generator along with a water metering pump of capacity 50-1000 ml/h to generate super-heated steam up to the temperature of 400° C. and electrically heated steam generator is equipped with thermocouples to measure heater temperature and inside temperature as well as having safety valve and rupture disc.

5. The Thermogravimetric Reactor (TGR) as claimed in claim 1, wherein said reactor has balance chamber above the reactor to house digital weighing balance to measure the accurate weight of the solid materials placed inside the reactor and balance chamber and having provision of continuous inert gas purging to protect the balance from overheating as well as to shield from corrosive and reactive gaseous environment.

6. The Thermogravimetric Reactor (TGR) as claimed in claim 1, wherein said reactor has jacketed spool piece with the provision of continuous inert gas purging as well as circulation is placed between the balance chamber and the reactor to protect the balance from the overheating, corrosive and reactive gaseous environment.

7. The Thermogravimetric Reactor (TGR) as claimed in claim 1, wherein said reactor has easily removable high temperature alloy vertical tube flanged end type Reactor with electrically heated furnace of operating temperature up to 1000° C. and pressure 1 atmosphere having 4 inches NB diameter and 2 meter length, having provision of upward and downward movement of the furnace along the length of the reactor for the purpose of sudden heating/cooling of the sample as per the process requirement.

8. The Thermogravimetric Reactor (TGR) as claimed in claim 1, wherein the device has a set of sample container of different sizes and shapes,
capable to hold solids in lump/granular/powder form with varying particle sizes ranging from micron level to 25 mm taking weight in the wide range of mg level to 100 g;
made of suitable alloy/ceramic material;
having provision of hanging arrangement from the weighing balance with chain/wire of adjustable length made of suitable alloy such that sample container is placed at the middle of the heating zone of the furnace heater inside the reactor just above the reactor temperature element for measuring the sample temperature accurately.

9. The Thermogravimetric Reactor (TGR) as claimed in claim 1, wherein said reactor has Nitrogen flushing arrangement to tackle any kind of emergency during operation by diluting reactant components in the reactor to stop sudden temperature shoot-up.

10. The Thermogravimetric Reactor (TGR) as claimed in claim 1, wherein said reactor has weighing balance of capacity up to 250 g with the accuracy of 0.0001% is connected with PLC-SCADA for control and Data Acquisition to record the weight changes of sample continuously with time and temperature.

11. A process to study weight changes behaviour of solids during thermo-chemical reactions in the gaseous environment of different gases at high temperature and atmospheric pressure using Thermogravimetric Reactor (TGR) as claimed in claim 1 comprising the steps of:
i. taking solid sample in lump/granular/powder form up to 100 g in the sample container;
ii. hanging the sample containing crucible inside the reactor by chain of adjustable length from the bottom of the weighing balance;
iii. switch on of the weighing balance and closing of the balance chamber as well as switch on of the PLC-SCADA Control and Data Acquisition system;
iv. starting of Nitrogen gas purging in the balance chamber at the rate of 1 LPM;
v. lifting of the reactor furnace up to the marked position of the reactor such that sample containing bucket remains at the middle of the furnace;
vi. starting of gas flow of Nitrogen at the rate of 1-10 LPM;
vii starting of gas flowmeter and water circulation in the condenser;
viii. switch on of the pre-heater and mixer-cum-heater and setting of temperature at 400° C.;
ix. switch on of steam generator as per requirement and setting of temperature at 400° C.;
x. switch on Reactor furnace and setting of desired temperature up to 1000° C.;
xi. after reaching the desired temperature of reactor furnace, introduction of desired reactive gas flow of air/CO₂/steam or their mixture at the rate of 1-10 LPM to the reactor and stopping of N₂ flow through the reactor.
xii. after reaching the desired temperature of reactor furnace as well as setting desired gas flow through the reactor, as per the requirement of experiment design of sudden heating and cooling, lifting of furnace along the length of the reactor to the pre-determined position such that the sample container remained at the middle of the furnace (in this case, furnace remained in down position earlier);
xiii. starting of Gasification reaction in desired atmosphere of Air/Air-steam/CO₂an their mixture in any proportion;
xiv. collection of out-going gas from the sample port for off line gas analysis as per requirement or coupling of online gas analyzer for instant analysis.
xv. after completion of the reaction, switch off of the steam genitor, water metering pump, all the furnaces and reactive gaseous flow; starting of N₂ flow at the rate of 3 LPM through the reactor;
xvi. recording of the data through control panel was stopped and taken the data and graphs for study and calculation;
xvii. placing down the furnace heater along the reactor to its pre-marked position;
xviii. after cooling the reactor tube, switch off of the weighing balance, stopping of N₂ flow through balance chamber, opening of the balance chamber and taking out of sample bucket.

12. The Thermogravimetric Reactor (TGR) as claimed in claim 1, wherein said device is to study weight changes behaviour
of any carbonaceous solids and catalysts;
in lump/granular/powder form with varying particle sizes ranging from micron level to 25 mm;
taking weight in the wide range of mg level to 100 g;
during thermo-chemical reactions (solid-gas, gas-gas) in the gaseous environment of different gases, such as inert and different reactive gases including but not limited to N₂, Ar, He, air, O₂, CO₂, steam or their mixtures of any proportion (0-100%) up to the maximum operating temperature of 1000° C. and at atmospheric pressure;
during pyrolysis/combustion/gasification/different types of gas-solid reactions/catalytic gas-gas reactions/isothermal and non-isothermal reactivity and kinetics of different reactive solids or solids having catalytic potentiality in lump/granular/powder form having particle sizes from micron level to 25 mm and taking weight in the wide range of mg level to 100 g, so that the reactivity reflects overall (apparent) reactivity of feed samples in its original size to depict the actual phenomena taking place inside the gasifier as well as to study intrinsic (diffusion free) and extrinsic (diffusion resistance) kinetics.

13. The Thermogravimetric Reactor (TGR) as claimed in claim 1, wherein said reactor has on line gas analyzer connected with Gas Sampling Port to test product gas composition with the help of in the exit line or collecting the outgoing gas from the sampling port with the help of any gas sample collection arrangement for off line gas analysis purpose.

14. The Thermogravimetric Reactor (TGR) as claimed in claim 1, wherein said reactor has entire tubing from steam generator to reactor is heat traced to maintain temperature up to 400° C. and gas line after mixer-cum-super heater is fed to the reactor in such a position that it is just above the heating zone of the reactor for not allowing the condensation of steam.

15. The Thermogravimetric Reactor (TGR) as claimed in claim 1, has process control and data acquisition system comprising of PLC-SCADA control station along with alarm system, safety fuses, safety managements inputs for power failure, high temperature limits, sensor burnout and shorting, high flow limits, safety management outputs to terminate power to heaters.
